(19) United States
(12) Patent Application Publication
(10) Pub. No.: US 2019/0358117 A1
(43) Pub. Date: Nov. 28, 2019

(54) Massage Pod Tool

(71) Applicant: Mark Edward Connelly, Thousand Oaks, CA (US)

(72) Inventor: Mark Edward Connelly, Thousand Oaks, CA (US)

(21) Appl. No.: 16/378,423

(22) Filed: Apr. 8, 2019

Related U.S. Application Data
(60) Provisional application No. 62/675,552, filed on May 23, 2018.

(51) Int. Cl. A61H 15/00

(52) U.S. Cl. CPC A61H 15/0092; A61H 2015/0042; A61H 2015/0064

(57) ABSTRACT

A massage tool comprising a cylindrical tube with a closed end and an open end, a plurality of balls disposed within the cylindrical tube, and a ring that surrounds the cylindrical tube and compresses the open end of the cylindrical tube closed. The cylindrical tube is comprised of flexible and stretchable material. The balls are inserted through the open end of the cylindrical tube and the balls are movable within the cylindrical tube. The ring is movable longitudinally across the outer surface of the cylindrical tube.

### BACKGROUND OF THE INVENTION

### 1. Field of the Invention

The present invention is in the technical field of massage, and more particularly to a tool used to perform a massage.

### 2. Background

Currently, traditional massage is performed by a person using various techniques and applying various degrees of pressure against the body to release fascia and loosen muscles. The pressure is applied using hands, arms, and even feet for most massage techniques. Alternately, massage can be performed using a hand tool of some kind. Massage tool designs can be as simple as a stick, a ball, a roller, a rod with rollers and the many variations of those objects. Massage tools that are held in the hand, or moved by the hand, are used to apply pressure, sliding, rolling, and other techniques during massage. Whether a massage is applied by using a body part, such as the hand or arm, or if hand tools are used, the person giving the massage to one's self or to another person will have to apply force. The force required to do an effective massage may be too much for many people to handle easily or to do repetitively. The result of the applied force may not be effective at loosening up fascia and muscles.

Additionally, even though massage hand tools currently have a wide range of design variations, most massage hand tools are small, have limited contact areas, and only work on a small area of the body at one time, or are only suitable for certain areas of the body.

Other massaging tools, like foam rollers, require the person using the tool to apply their own body mass to force the massage tool into the body part. This limits the types of massage techniques that can be done and can make the massage hard to do and stressful. The weight of ones body can even be too high for the body part being massaged and excessive soreness or injury to the muscle can be a result.

Massaging a body part of one's self or another person can be difficult or not effective. What is needed, therefore, is a massage tool that is flexible and resizable with a plurality of massaging balls that are movable along the length of the massage tool. The balls can be positioned, by the person using the massage tool, to target different areas of the body being massaged. Movable balls also enable the massage tool accommodate different body sizes and body shapes by allowing the massage tool to lengthen and flex. Additionally, it would benefit the user of the massage tool and the recipient of the massage if the balls are weighted, whereby the weight amount assists with applying pressure to the body to help release fascia and muscle tension.

### SUMMARY OF THE INVENTION

The present invention provides a massage tool for use while performing a massage to assist with applying pressure and targeting muscles more effectively.

According to embodiments of the present invention, a massage tool comprises a cylindrical tube with a closed end and an opened end, a plurality of balls contained within a portion of the cylindrical tube, a ring surrounding the exterior surface of the cylindrical tube to close the opened end, and a remaining portion of the cylindrical tube, not containing the balls, forms a handle.

The material of the cylindrical tube is flexible and stretchable. The inside diameter of the cylindrical tube is smaller than the outside diameter of the balls contained inside. The smaller diameter of the cylindrical tube combined with the flexible and stretchable material of the cylindrical tube encases the balls with tension, whereby the tension amount reduces movement of the balls and is sufficient to hold the balls in position during normal use of the massage tool. The tension of the flexible and stretchable material around the plurality of the balls creates a waveform profile along the longitudinal length of the massage tool, whereby a valley curve is formed between adjacent balls.

The balls are movable within the interior of the cylindrical tube by the user of the massage tool. The length of the contact area of the massage tool is increased when balls are positioned longitudinally further apart from the center of the cylindrical tube. The length of the contact area of the massage tool is decreased when balls are positioned longitudinally together towards the center of the cylindrical tube. The length of the massage pod tool is increased when the quantity of balls inserted into the cylindrical tube are increased.

Movement of the balls toward the open end of the cylindrical tube is controlled by the position of the ring. A ring positioned adjacent to the ball closest to the open end of the cylindrical tube prevents further movement of the balls during normal use of the massage tool. A ring positioned further longitudinally away from the ball closest to the open end of the cylindrical tube provides more space for the balls to move further longitudinally apart. The inside diameter of the ring is smaller than the outside diameter of the cylindrical tube, whereby the cylindrical tube is compressed closed by the ring. The compressive force created by the pinching of the cylindrical tube is sufficient to hold the ring in position during normal use of the massage tool.

The outside diameter of each ball can be the same or the outside diameter of each ball can be different from another ball.

The length of the cylindrical tube is longer than the combined length of the plurality of the balls disposed longitudinally within the cylindrical tube, the width of the ring, and any empty space between the balls. The remaining length of the cylindrical tube, not containing the balls, extends outward from the ring to form a handle.

It is a further object of the present invention that the balls are weighted balls. In one embodiment, the balls are comprised of a natural rubber or synthetic rubber shell with a hollow core. The hollow core contains weight material. The weight material is composed of metal, sand or a mixture of the two.

Other features and advantages of the present invention should become apparent from the following description, taken in conjunction with the accompanying drawings, which illustrate, by way of example, the principles of the invention.

### BRIEF DESCRIPTION OF THE DRAWINGS

FIG. 1 is a perspective view of a massage tool with two balls inside.

FIG. 2 is a perspective view of a ring.

FIG. 3 is a perspective view of a massage tool with two balls inside. The ring has been moved to the right side and the balls are separated in the middle of the massage tool.

FIG. 4 is a perspective view of a two ball massage tool with a section of the pod cut out to expose the balls inside. The balls are adjacent to each other.

FIG. 5 is a perspective view of a two ball massage pod tool with a section of the pod cut out to expose the balls inside. The balls have been separated in the middle of the massage tool.

FIG. 6 is a perspective view of a massage tool with four balls inside. The balls are adjacent to each other.

FIG. 7 is a perspective view of a massage tool with four balls inside. The ring has been moved to the right side and the balls are separated in the middle of the massage tool.

FIG. 8 is an exterior view of a weighted ball with a section of the ball cut out to expose the interior containing weight material.

FIG. 9 is a sectional view of a weighted ball exposing the interior containing weight material.

FIG. 10 is a perspective view of a massage tool with six balls inside and bent in a non-linear shape. The illustration shows the balls moved apart in the center and the massage tool bent in a v-shaped manner.

FIG. 11 is a perspective view of a massage tool showing a ball inserted partially through the open end of the cylindrical tube.

### DETAILED DESCRIPTION

All descriptions and drawings are for the purpose of describing embodiments of the present invention and are not intended to limit the scope of the present invention. It is also to be understood that the phraseology or terminology employed herein is for the purpose of description and not of limitation.

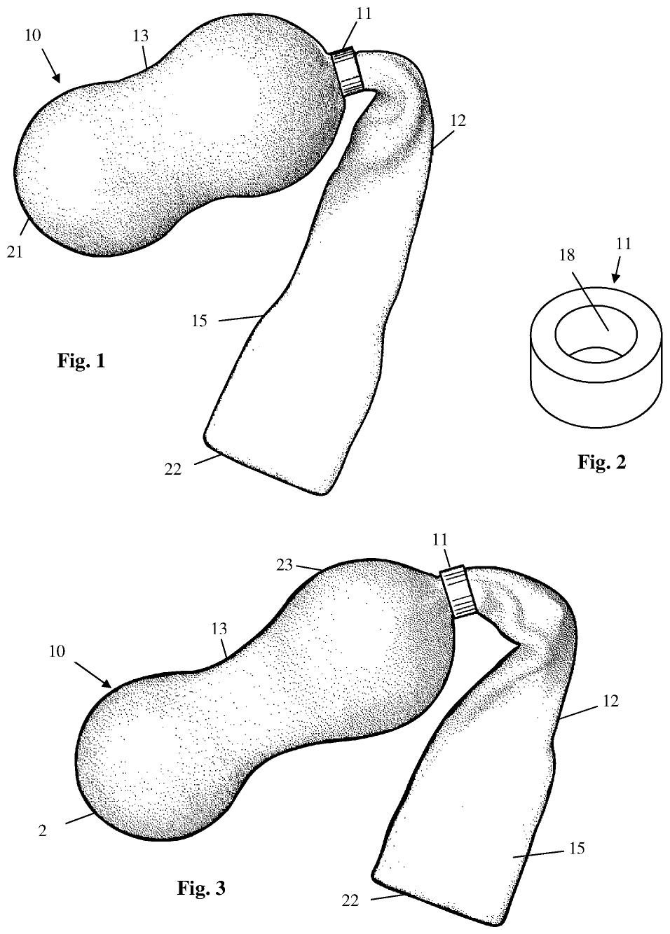

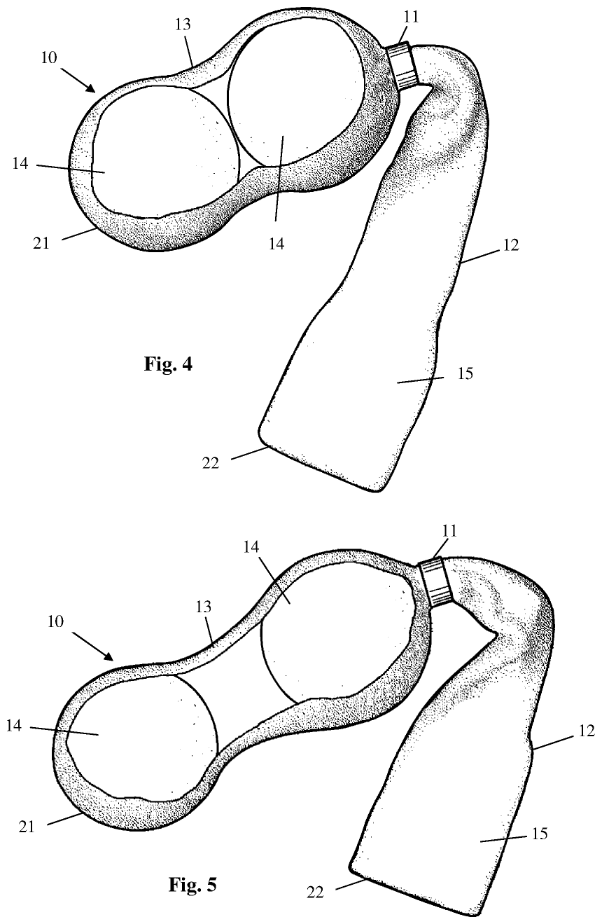

Referring now to one embodiment of the massage tool in more detail, FIG. 1 is a perspective view, as viewed from the side and top, of the massage tool 10 with two balls 14 inside a cylindrical tube 12 with a ring 11 positioned adjacent to one of the balls 14. One embodiment of the ring 11 is illustrated in FIG. 2. The balls 14 are positioned adjacent to each other inside said cylindrical tube 12 to form a pod containing balls. The cylindrical tube 12 is permanently closed on one end 21 to create a sock-like structure. The other end 22 is open to allow the insertion of said balls 14 into the cavity of said cylindrical tube 12 as illustrated in FIG. 11. The open end 22 of the cylindrical tube 12 is closed by the compression of the cylindrical tube 12 material at the location where the material passes through and contacts the inner wall surface 18 of the ring 11. The inner circumferential surface of the ring 11 compresses the material of the cylindrical tube 12 because the diameter of the ring 11 is smaller than the diameter of the cylindrical tube 12. The compression force created by the pinching of the cylindrical is high enough to hold the ring 11 in place during normal use of the massage pod tool 10. However, the ring 11 is movable by the user of the massage tool 10 and the ring 11 is removable from the cylindrical tube 12 to enable insertion of the balls 14 into the cylindrical tube 12 as illustrated in FIG. 11. The thickness of the cylindrical tube 12 material and the type of material will also affect the ability of the ring 11 to compress and stay in position. A cylindrical tube 12 made from thicker material will compress more than a cylindrical tube 12 made from thinner material when the cylindrical tube 12 passes through the opening of the ring 11, whereby said compression creates a gripping force. The section of said cylindrical tube 12 that does not contain balls 14 functions as a handle 15. FIG. 4 shows the same perspective view with a section of the cylindrical tube 12 cut out to expose the balls 14 inside the cylindrical tube 12. In another embodiment of the massage tool, the open end 22 side of the cylindrical tube 12 can be permanently closed by way of stitching, gluing or other means after the desired quantity of balls 14 have been inserted into the cavity of the cylindrical tube 12.

Referring to one embodiment of the massage tool in FIG. 1, the cylindrical tube 12 can be made from various materials. The material should be flexible and stretchable. The material can be made from natural or synthetic materials. Fabrics produced from nylon, polyester, cotton, or combinations thereof are suitable materials for producing the cylindrical tube 12, but the construction is not limited to those materials. The inside diameter of the cylindrical tube 12 should be smaller than the outside diameter of the balls 14 so that the cylindrical tube 12 encases the outer surface of the balls 14 with tension. A flexible cylindrical tube 12 that has a smaller inside diameter than the inserted balls 14 will form a curve 13 between the balls 14. The curve 13 is created by the tension of the smaller diameter cylindrical tube against two adjacent larger diameter balls 14. A plurality of two or more balls 14 inside the cylindrical tube 12 will create a waveform profile shape along the longitudinal length of the massage pod tool. The valley created by the curve 13 of the waveform will create a gap between the surface of the massage tool 10 and the surface skin of the person receiving a massage. The gap created by the curve 13 allows the descending edge of the ball to sink into muscles when the massage tool 10 is moved across the body. The gap created by the curve 13 is also of benefit when massaging around bony areas of the body that are close to muscles being massaged. Parts of the body, such as the edge of a shoulder blade, can be avoided by placing the curve 13 over the body area to be avoided. The supraspinous ligament that runs along the spine of the back is another example of a non muscular area of the body that is not massaged. The massage tool 10 can roll or move along the back and the gap created by the curve 13 will avoid the ligament area when the curve 13 is positioned over the supraspinous ligament area.

Referring to FIG. 2, one embodiment of the ring 11 is shown. The ring 11 can be comprised of various materials such as natural rubber, synthetic rubber, plastic, or metal. The material used will be dictated by the desired design. The inside diameter of the ring 11 does not have a set size, but the inside diameter of the ring 11 is smaller than the outside diameter of the balls 14 and small enough to enable the material of the cylindrical tube 12 to fit through the ring 11 with a tight fit and compress the cylindrical tube 12 closed. The compression amount should be sufficient to hold the ring 11 in place during normal use of the massage tool. The inside surface 18 of the ring 11 can be smooth or textured. A textured surface provides more friction against the outer surface of said cylindrical tube 12. Although the cylindrical tube 12 has a diameter that enables the ring 11 to stay in the set position during normal use of the massage tool, the ring 11 is movable by the user of the massage tool 10. The user can slide the ring 11 down the outside surface of the cylindrical tube 12 to reposition the ring 11 or remove the ring 11 from the cylindrical tube 12.

Referring to the one embodiment of the massage tool in FIG. 3, the illustration is a perspective view of a massage tool 10 with two balls 14 inserted inside the cylindrical tube 12 as viewed from the side and top. The balls 14 inside the cylindrical tube 12 have been separated. FIG. 5 shows the same perspective view with a section of said cylindrical tube 12 cut out to expose the balls 14 inside said cylindrical tube 12. The ring 11 has been moved further to the right and the ball 14 in the second position 23 from the left has been moved further to the right side of the massage tool 10. This separation creates a longer curve 13 in the middle of the massage tool 10. Once the weighted balls 14 are moved to the desired position within the cylindrical tube 12, the ring 11 is moved adjacent to the ball on the right side 23 to restrict any further outward movement of the balls 14. Moving the balls 14 further apart creates a longer massage tool 10. A longer massage tool 10 enables the massage tool 10 to target different muscles while the user performs massaging movements.

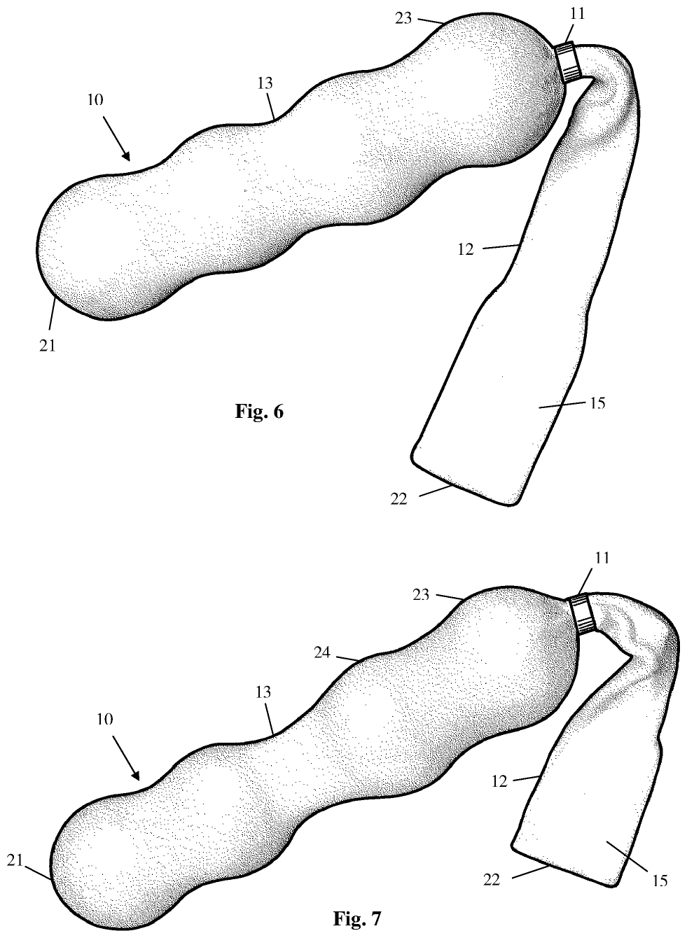

Referring to another embodiment of the massage tool in FIG. 6, the illustration is a perspective view of a massage tool 10 with four balls 14 inserted inside the cylindrical tube 12 as viewed from the side and top. The balls 14 are adjacent to each other inside the cylindrical tube 12 as was illustrated previously in FIG. 4. The length of the cylindrical tube 12 is long enough to accommodate four balls 14 positioned adjacent to each other and allow for the balls 14 to be separated and moved to the desired position along the interior length of the cylindrical tube 12. Once the position of each ball 14 is set, the sliding adjustment ring 11 is positioned adjacent to the ball 14 in the fourth position 23 from the left as illustrated in FIG. 6. The location of the ring 11 will restrict the movement of the balls 14 inside the cylindrical tube 12 and prevent the balls 14 from separating further apart. A massage tool 10 with four balls 14 is longer than a massage tool 10 with two balls 14 of identical outside diameter. A longer massage tool 10 can cover a larger surface area of the body part being massaged and target more muscles at the same time. The type of massage and area of the body being massaged will make different configurations of the massage tool desirable. A massage pod tool 10 comprised of four or more balls 14 is ideal for using on back muscles.

Referring to one embodiment of the massage tool in FIG. 7 the illustration is a perspective view of a massage tool 10 with four balls 14 inserted inside as viewed from the side and top. The ring 11 has been moved to the right side and the balls 14 in the third position 24 and fourth position 23 from the left are moved further to the right side of the cylindrical tube 12. This creates a longer curve 13 in the middle of the massage pod tool 10. The ring 11 is positioned adjacent to the ball 14 in the fourth position 23 to restrict further outward movement of the balls 14 inside the cylindrical tube 12. The outer surface of one ball 14 can touch the outer surface of another ball 14, or the balls 14 can be separated with any amount of space between the balls 14. Spacing balls 14 further apart will elongate the usable surface area of the massage tool 10. Because the balls 14 inside a massage tool 10 are movable, the position of the balls 14 can be changed to help target different muscles or accommodate people of different body sizes. The length of the cylindrical tube 12 of the massage tool 10 can be any length that accommodates the size and desired number of balls 14 inserted inside the cylindrical tube 12, plus the extra length to accommodate separating the balls 14 to the desired positions within the cylindrical tube 12, the width of the ring 11, and the desired length of the remaining material that can function as a handle 15.

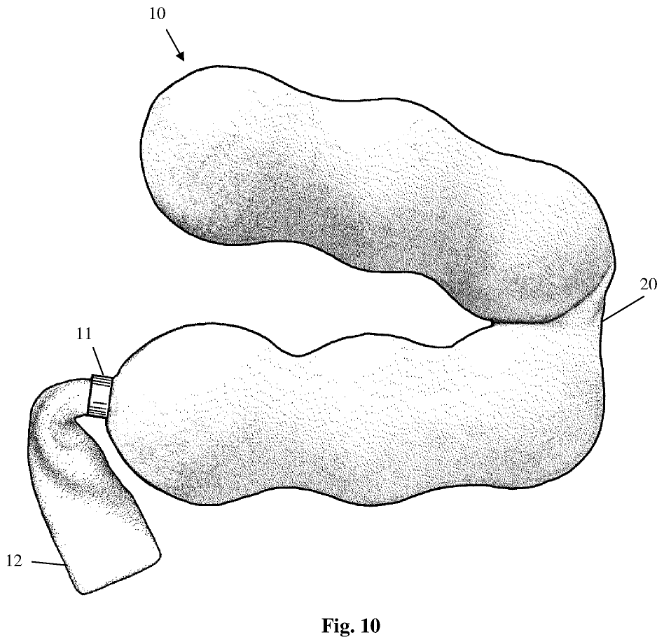

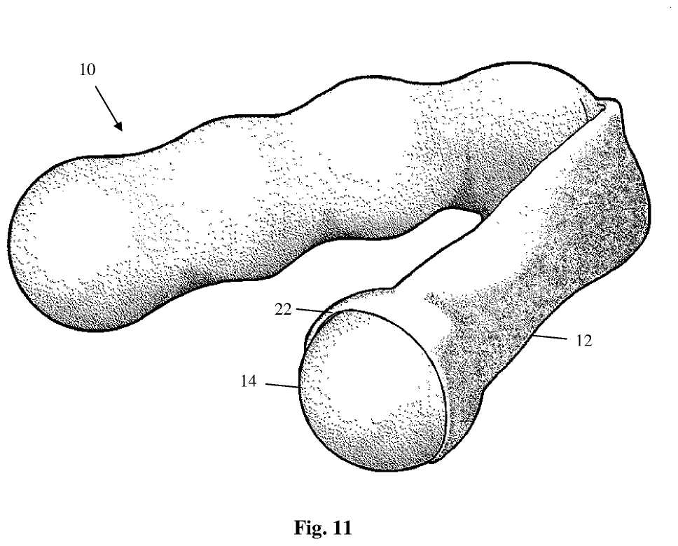

Referring to another embodiment of the massage tool as shown in FIG. 10, the illustration shows a massage tool 10 with six balls inserted inside as viewed from the side and top. The massage tool 10 is bent to form a non-linear shape. The flexibility of the cylindrical tube 12 material and the length of the cylindrical tube 12 will enable the user to vary the shape of the massage tool 10 to facilitate different massaging techniques. The v-shape configuration, as illustrated in FIG. 10, is created by moving the balls apart and away from the center 20 of the massage tool 10 a long enough distance apart to enable said massage tool 10 to be bent to the desired angle.

Referring to FIG. 7, the remaining end of the cylindrical tube 12 that does not contain balls 14 can function as an optional handle 15. The handle 15 can be held in the hand of the massager to help apply various massage techniques. The handle 15 can also be held by use of the massage tool 10 when the user moves the ring 11. The length of the handle 15 can vary based on design need. With balls 14 positioned to the desired widest spacing, the length of the handle should accommodate a large sized adult hand. In one embodiment, the handle 15 of the massage tool has a minimum length of 6 inches (15 centimeters) from the end of the ring 11 when the balls 14 are moved to the widest desirable position.

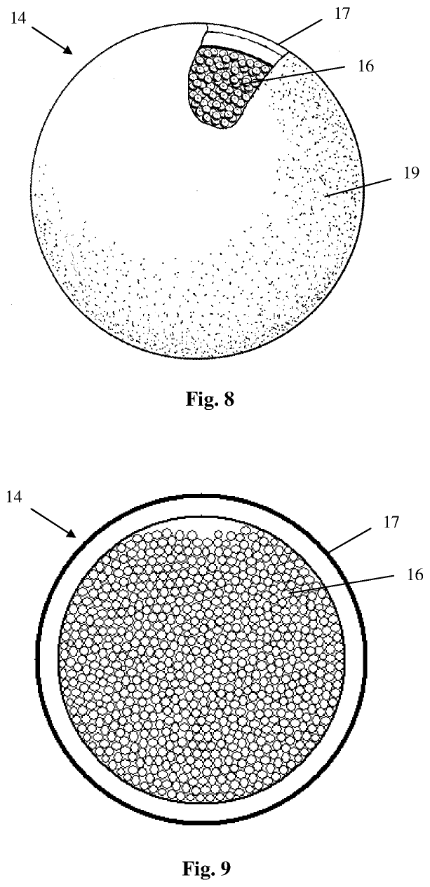

In FIG. 8, one embodiment of a massage tool ball is shown. The ball 14 is hollow and contains weight material 16. Illustrated is an exterior view of the ball 14 with a section of the ball 14 cut out to expose an interior containing the weight material 16. The shell 17 of the ball 14 can be made from natural or synthetic rubber. The surface 19 of the ball 14 can be smooth or textured. A textured surface can be beneficial to help restrict further movement of the balls 14 within the cylindrical tube 12 as a textured surface creates more friction than a smooth surface. In another embodiment of the massage tool ball 14, the surface 19 of the ball 14 can be covered with textured cloth, as would be done when manufacturing a tennis ball. The amount of flex or rigidity of the shell 17 of the ball 14 can vary depending on the desired design and the intended use of the massage tool 10. When the shell 17 is highly rigid and less flexible, the firmness will increase the pressure point sensation when pressed against a muscle. When the shell 17 is less rigid and more flexible it will produce a smaller pressure point sensation when pressed against a muscle.

Referring to FIG. 9, a ball 14 can be filled with weight material 16 of various types. The weight material 16 can be comprised of sand, metal, or a combination of the two. Metal particles or metals balls, made from metal like iron or steel, are preferred material types for adding to the balls 14 due to weight and cost. Per volume metal is heavier than sand, but generally has a higher cost than sand. The amount of weight material inside the ball 14 will be only limited by the diameter of the ball 14 and the interior volume of the ball 14. A ball 14 with an inside diameter between 2.3 inches (5.8 centimeters) and 2.5 inches (6.4 centimeters) will have an average weight around 1 pound (0.45 kilograms) when filled with steel weight material. A ball 14 with an inside diameter between 2.8 inches (7.1 centimeters) and 3.0 inches (7.6 centimeters) will have an average weight around 2 pounds (0.9 kilograms) when filled with steel weight material. Each ball 14 can have the same outside diameter, or the diameter of one ball 14 can be different from the diameter of another ball 14.

The composition and design of the weight material 16 can affect the rigidity of the ball 14. Weight material 16 that is loose in structure and not packed tightly into the cavity of the ball 14 will allow the shell 17 to flex more. Types of weight material 16 with a loose structure include beach sand, metal particles, or metal balls. Weight material 16 that is not loose in structure or weight material that is packed tightly into the cavity of the ball 14 may not allow said shell 17 to flex much or possibly not at all. The ball 14 can be completely filled with said weight material 16 or partially filled. The amount of the weight material 16 used is not set to a specific amount but will vary based on the size of the ball 14 and the type of weight material 16. In other embodiments, the ball can be completely solid and comprised metal.

A massage 10 tool containing a plurality of two or more balls 14 containing weight material 16 of sufficient mass will sink into muscles deeper and more effectively than a similar tool containing non-weighted balls. A weighted massage tool 10 will require less force from the person giving the massage to be able to give an effective massage. It is the plurality of two or more balls 14, with weight material 16 inside, that combine together to create an even more effective massaging tool. In referring to the balls 14, the weight amount of each weighted ball 14 is preferably 1 pound (0.45 kilograms) or greater. The higher the weight amount, the greater the compression of muscles will be. Higher weight amounts are more beneficial when massaging larger muscle areas such as the back and thighs for many people. A massage tool 10 containing balls that are weighted will benefit the person giving the massage as less work will generally be required by the person performing the massage when applied using proper techniques.

In conclusion, the present invention provides a massage tool with a flexible design that can be rolled, rocked, slid, or compressed against muscles of the body while the person giving the massage performs various massage techniques. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within scope and spirit of the disclosed invention as expressed in the claims.

I claim:

1. A massage tool, comprising:
a cylindrical tube, formed from flexible and stretchable material, having a closed first end and an open second, wherein said open second end provides access to interior of said cylindrical tube;
a plurality of balls disposed within said cylindrical tube; and,
a ring having an inner circumferential surface and an outer circumferential surface, wherein said inner circumferential surface of said ring surrounds the exterior surface of said cylindrical tube, and said inside inner circumferential surface of said ring has an inside diameter smaller than the outside diameter of said cylindrical tube, whereby said open second end of said cylindrical tube is compressed closed.

2. The massage tool of claim 1, wherein said cylindrical tube has a length that is longer than the combined length of the plurality of said balls disposed longitudinally within said cylindrical tube, the width of said ring, and any empty space between said balls, whereby the remaining length of said cylindrical tube not containing said balls, extends outward from said ring and provides a means for creating a handle.

3. The massage tool of claim 1, wherein the interior volume of said cylindrical tube available for containing the plurality of said balls disposed within said cylindrical tube is set by the position of said ring surrounding said cylindrical tube.

4. The massage tool of claim 1, wherein the compressive force created by the pinching of said cylindrical tube between said inner circumferential surface of said ring holds said ring in position.

5. The massage tool of claim 1, wherein said ring is movable longitudinally along the exterior surface of said cylindrical tube.

6. The massage tool of claim 1, wherein said ring is removable form said cylindrical tube.

7. The massage tool of claim 1, wherein said ball is comprised of a first material and the hollow inside contains a second material that is different from the first material.

8. The massage tool of claim 7, wherein said first material comprises rubber.

9. The massage tool of claim 7, wherein said first material comprises synthetic rubber.

10. The massage tool of claim 7, wherein said second material comprises metal.

11. The massage tool of claim 7, wherein said second material comprises sand.

12. The massage tool of claim 1, wherein each said ball has an outside diameter larger than the inside diameter of said cylindrical tube.

13. The massage tool of claim 12, wherein the outside diameter of each said ball is the same.

14. The massage tool of claim 12, wherein the outside diameter of said ball is different from another said ball.

15. The massage tool of claim 1, wherein said plurality of balls are movable within the interior volume of said cylindrical tube set by the position of said ring.

16. The massage tool of claim 1, wherein said flexible and stretchable material encases the plurality of said balls with tension, whereby said tension reduces movement of said balls inside said cylindrical tube.

17. The massage tool of claim 16, wherein the tension of said flexible and stretchable material around the plurality of said balls creates a waveform profile along the longitudinal length of said massage tool, whereby a valley curve is formed between adjacent balls.
